(19) United States
(12) Patent Application Publication
(10) Pub. No.: US 2026/0317576 A1
(43) Pub. Date: Oct. 15, 2026

(54) MULTIFUNCTIONAL HARD COATING FILM AND MANUFACTURING METHOD THEREOF

(71) Applicant: KR Advanced Electronic Materials Co., Ltd., Busan (KR)

(72) Inventors: Sung Ho Jin, Busan (KR); Hyun Don Kim, Anyang-si (KR)

(73) Assignee: KR Advanced Electronic Materials Co., Ltd., Busan (KR)

(21) Appl. No.: 19/549,019

(22) Filed: Feb. 25, 2026

(30) Foreign Application Priority Data
Apr. 15, 2025 (KR) 10-2025-0048529

(51) Int. Cl. C09D 133/08; B05D 3/06; C09D 7/40; C09D 7/62

(52) U.S. Cl. CPC C09D 133/08; B05D 3/067; C09D 7/62; C09D 7/69; B05D 2502/00

(57) ABSTRACT

A manufacturing method of a multifunctional hard coating film, includes preparing an ultraviolet-curable resin composition, preparing a coating solution by mixing silica aerogel and a functional additive with the resin composition, forming a coating layer by coating the coating solution on a transparent polymer substrate, and curing the coating layer by irradiating the coating layer with ultraviolet light. A hard coating solution includes an ultraviolet-curable resin composition, silica aerogel, an anti-fouling resin, an antistatic agent, and an antibacterial agent. The ultraviolet-curable resin composition includes an acrylate-based curable resin, a solvent, a photoinitiator, and a leveling agent.

### CROSS-REFERENCE TO PRIOR APPLICATION

This application claims priority to Korean Patent Application No. 10-2025-0048529 (filed on Apr. 15, 2025), which is hereby incorporated by reference in its entirety.

### BACKGROUND

The present disclosure relates to a multifunctional hard coating film and a manufacturing method thereof, and more specifically, to a multifunctional hard coating film capable of stably realizing five core functions within a single composition without mutual interference, and a manufacturing method thereof.

Recently, as the technological level of advanced products such as electronic devices, displays, and wearable devices has rapidly advanced, surface protective coating technologies for protecting the appearance and functions of products are required to provide multifunctionality beyond merely preventing scratches or mitigating external impacts. In particular, anti-glare (AG) for improving user visibility and reducing eye fatigue, anti-reflection (AR) for suppressing external light reflection to enhance display clarity, anti-fouling (AF) for minimizing adhesion of contaminants, anti-static (AS) for preventing dust attraction and circuit damage caused by static electricity, and anti-bacterial (AB) for inhibiting proliferation of pathogenic bacteria on a surface are evaluated as extremely important functions that determine not only user convenience and hygienic safety but also the lifespan and reliability of products.

However, conventional hard coating film technologies mostly remain at a level of providing only some of the functions such as AG, AR, AF, AS, and AB, that is, limited combinations of two or three functions. Since materials and process conditions required to realize each function are different, a multilayer structure in which separate coating layers are independently applied has mainly been used. Although individual functions can be realized, such an approach has limitations including increased process complexity, increased material costs, and deterioration in flexibility and durability due to increased thickness.

In order to overcome the technical limitations, a new hard coating technology capable of integrally realizing five core functions, AG, AR, AF, AS, and AB, in a single-layer structure within a single composition has developed. The multifunctional integrated coating based on a single layer simplifies the process, reduces manufacturing costs, and minimizes film thickness. Above all, the multifunctional integrated coating has significant technical value in that it provides high versatility applicable to next-generation electronic devices having various shapes such as curved, ultra-thin, and flexible substrates.

Meanwhile, in some industrial fields, extremely precise and stable implementation of anti-reflection (AR) effects is essentially required. For example, in medical high-resolution monitors, precision optical sensors, semiconductor lithography equipment, and the like, it is necessary to minimize optical noise and the influence of external reflection, and thus it is often difficult to secure sufficient performance with only a single-layer coating.

In order to satisfy such high-performance requirements, the present disclosure has developed a hard coating film in which a mesoporous hollow silica layer is selectively introduced directly above or directly below a substrate, thereby precisely controlling the refractive index and consequently securing excellent reflection reduction performance.

Such a structural design maintains the advantages of the single-layer coating while providing flexible expandability to an advanced multilayer design for specific functions, thereby satisfying customized requirements in various industrial fields.

### REPLATED ART

Korean Patent No. 10-0926220, entitled “Hard Coating Composition and Anti-Reflection Film Using the Same”
Korean Patent No. 10-1047955, entitled “Diffusion Film and Hard Coating Composition for Protective Film”

### SUMMARY

Accordingly, the present disclosure has been made to solve the above-mentioned problems occurring in the prior arts, and it is an objective of the present disclosure to optimize the composition of a single formulation in order to overcome the technical limitation of conventional hard coating films, which provide only limited combinations of some (two to three) functions among anti-glare (AG), anti-reflection (AR), anti-fouling (AF), anti-static (AS), and anti-bacterial (AB) properties.

It is another objective of the present disclosure is to overcome problems in conventional complex film manufacturing processes, including securing compatibility between materials of respective layers and requiring individual curing processes, and to overcome difficulties such as deterioration of flexibility and durability due to increased thickness.

The objectives of the present disclosure are not limited to those mentioned above, and other objectives not mentioned herein will be clearly understood by those skilled in the art from the following description.

To accomplish the above object, according to the present disclosure, there is provided a manufacturing method of a multifunctional hard coating film including: preparing an ultraviolet-curable resin composition; preparing a coating solution by mixing silica aerogel and a functional additive with the resin composition; forming a coating layer by coating the coating solution on a transparent polymer substrate; and curing the coating layer by irradiating the coating layer with ultraviolet light.

In one embodiment of the present disclosure, the silica aerogel has a particle size of 1 to 20 μm and a pore size of 3 to 200 nm.

In one embodiment of the present disclosure, in the preparing of the coating solution, the coating solution is prepared by mixing 1 to 7 parts by weight of the silica aerogel, 1 to 5 parts by weight of an anti-fouling resin, 15 to 36 parts by weight of an antistatic agent, and 3 to 8 parts by weight of an antibacterial agent, based on 100 parts by weight of the resin composition.

In one embodiment of the present disclosure, in the forming of the coating layer, the transparent polymer substrate has a thickness of 10 to 500 μm.

In one embodiment of the present disclosure, the forming of the coating layer includes coating the coating solution on the transparent polymer substrate as a single layer.

In one embodiment of the present disclosure, the forming of the coating layer includes laminating a mesoporous hollow silica layer directly above or directly below the transparent polymer substrate.

In another aspect of the present disclosure, there is provided a hard coating solution including: an ultraviolet-curable resin composition including an acrylate-based curable resin, a solvent, a photoinitiator, and a leveling agent; silica aerogel; an anti-fouling resin; an antistatic agent; and an antibacterial agent.

In one embodiment of the present disclosure, the ultraviolet-curable resin composition includes 180 to 480 parts by weight of the solvent, 10 to 30 parts by weight of the photoinitiator, and 2 to 8 parts by weight of the leveling agent, based on 100 parts by weight of the acrylate-based curable resin.

In a further aspect of the present disclosure, there is provided a multifunctional single-layer hard coating film, wherein the hard coating solution is formed as a single layer on a transparent polymer substrate layer.

In a still further aspect of the present disclosure, there is provided a multifunctional multilayer hard coating film including: a transparent polymer substrate layer; a mesoporous hollow silica layer formed on the transparent polymer substrate layer; and a functional film layer formed on the mesoporous hollow silica layer from the hard coating solution.

In another aspect of the present disclosure, there is provided a multifunctional multilayer hard coating film including: a mesoporous hollow silica layer; a transparent polymer substrate layer formed on the mesoporous hollow silica layer; and a functional film layer formed on the transparent polymer substrate layer from the hard coating solution.

In one embodiment of the present disclosure, a thickness of the functional film layer formed from the hard coating solution is 1 to 20 μm.

In one embodiment of the present disclosure, a thickness of the mesoporous hollow silica layer is 60 to 300 nm.

In one embodiment of the present disclosure, the mesoporous hollow silica layer includes mesoporous hollow silica, and the mesoporous hollow silica has a particle size of 20 to 300 nm.

The multifunctional hard coating film according to the present disclosure not only simplifies the manufacturing process but also provides an effect of satisfying combined performances including optical transparency, mechanical durability, contamination resistance, antibacterial stability, and static electricity control in a well-balanced manner. Accordingly, the film can be widely applied to various fields in which optical functionality, surface protection, and static electricity control are simultaneously required, such as display panels, optical components for automobiles and mobile devices, and smart windows.

The effects of the present disclosure are not limited to those described above, and other effects not described herein will be clearly understood by those skilled in the art from the scope of the appended claims.

### BRIEF DESCRIPTION OF THE DRAWINGS

FIG. 1 is a process flowchart illustrating a manufacturing method of a multifunctional hard coating film according to a preferred embodiment of the present disclosure.

FIG. 2 is a schematic view illustrating a single-layer hard coating film according to a preferred embodiment of the present disclosure.

FIG. 3 is a schematic view illustrating a hard coating film including a mesoporous hollow silica layer according to a preferred embodiment of the present disclosure.

FIG. 4 is a schematic view illustrating a hard coating film including a mesoporous hollow silica layer according to a preferred embodiment of the present disclosure.

### DETAILED DESCRIPTION

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Moreover, some terms may be arbitrarily selected by the applicant, and in this case, the meaning of the selected terms will be described in detail in the detailed description of the present disclosure. Thus, the terms used herein have to be defined based on the meaning of the terms together with the description throughout the specification.

Unless otherwise defined, all terms (including technical and scientific terms) used herein have the same meaning as commonly understood by one of ordinary skill in the art to which this inventive concept belongs. It will be understood that terms, such as those defined in commonly used dictionaries, should be interpreted as having a meaning that is consistent with their meaning in the context of the relevant art and/or the present disclosure, and will not be interpreted in an idealized or overly formal sense unless expressly so defined herein.

The numerical range includes the numerical values defined in the range. All maximum numerical limits given throughout this specification include all lower numerical limits as if the lower numerical limits were clearly written. All minimum numerical limits given throughout this specification include all higher numerical limitations as if the higher numerical limit were clearly written. All numerical limits given throughout this specification will include all better numerical ranges within the broader numerical ranges, as if narrower numerical limits are clearly written.

The present disclosure relates to a multifunctional hard coating film and a manufacturing method thereof.

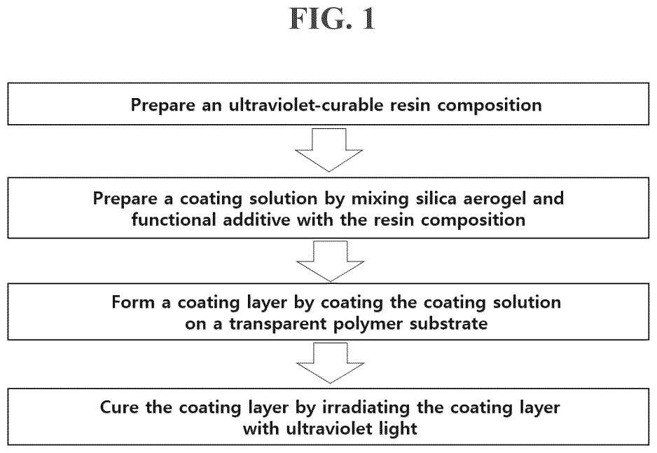

In a preferred embodiment of the present disclosure, as illustrated in FIG. 1, the manufacturing method of the multifunctional hard coating film may include: preparing an ultraviolet-curable resin composition; preparing a coating solution by mixing silica aerogel and functional additives with the resin composition; forming a coating layer by coating the coating solution on a transparent polymer substrate; and curing the coating layer by irradiating the coating layer with ultraviolet light.

Hereinafter, the manufacturing method of the multifunctional hard coating film according to the present disclosure will be described in detail step by step.

First, the manufacturing method of the multifunctional hard coating film may include preparing an ultraviolet-curable resin composition.

The ultraviolet-curable resin composition may be prepared by mixing an acrylate-based curable resin, a solvent, a photoinitiator, and a leveling agent.

Specifically, the ultraviolet-curable resin composition may be prepared by sequentially mixing the acrylate-based curable resin, the solvent, the photoinitiator, and the leveling agent, and after adding each ingredient, the mixture may be stirred for one to five minutes before introducing the next ingredient.

The mixing may be performed using a general high-speed stirrer at a speed of 100 to 1,000 rpm, and, if necessary, an ultrasonic disperser may be used alone or in combination with the stirring.

The acrylate-based curable resin includes a photopolymerizable functional group and may be at least one selected from the group consisting of monofunctional acrylate monomers, multifunctional acrylate monomers, and multifunctional acrylate oligomers that are commonly known in the art.

The monofunctional acrylate monomer may include hydroxyethyl acrylate (HEA), hydroxypropyl acrylate (HPA), isooctyl acrylate (IOA), stearyl acrylate, and the like.

The multifunctional acrylate monomer may include trimethylolpropane triacrylate (TMPTA), pentaerythritol tetraacrylate (PETA), ethylene glycol diacrylate (EGDA), 1,6-hexanediol diacrylate (HDDA), and the like.

The multifunctional acrylate oligomer may include epoxy acrylate, urethane acrylate, polyester acrylate, fluoro acrylate, and the like.

More preferably, the acrylate-based curable resin may be used by mixing the multifunctional acrylate monomer and the multifunctional acrylate oligomer, wherein a weight ratio of the monomer to the oligomer is preferably in a range of 10 to 50:50 to 90.

The solvent may be an alcohol-based solvent, a ketone-based solvent, an acetate-based solvent, a hexane-based solvent, a benzene-based solvent, or an ether-based solvent, and they may be used alone or in combination of two or more. For example, the solvent may include: alcohols such as methanol, ethanol, and isopropanol; ketones such as methyl ethyl ketone and diethyl ketone; acetates such as ethyl acetate and propyl acetate; hydrocarbons such as hexane, toluene, and xylene; and ethers such as diethylene glycol derivatives and propylene glycol monomethyl ether. In particular, in order to secure uniform surface properties of the film, it is preferable to induce sequential evaporation during drying by mixing high boiling point solvents with middle and low boiling point solvents.

The photoinitiator may be at least one selected from the group consisting of hydroxyketones, aminoketones, and hydrogen abstraction-type photoinitiators.

For example, the photoinitiator may include at least one selected from the group consisting of 2-methyl-1-[4-(methylthio)phenyl]-2-morpholinopropanone, diphenyl ketone, benzyl dimethyl ketal, 2-hydroxy-2-methyl-1-phenyl-1-propanone, 4-hydroxycyclophenyl ketone, 2,2-dimethoxy-2-phenylacetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexyl phenyl ketone, benzophenone, and diphenyl(2,4,6-trimethylbenzoyl)phosphine oxide.

The leveling agent serves to provide smoothness and coatability to a coating film, and various leveling agents commonly used in the art may be applied. For example, silicone-based, fluorine-based, and acrylic polymer-based leveling agents may be used, either alone or in combination of two or more. However, the leveling agent is not limited to the examples.

In this case, the ultraviolet-curable resin composition may be prepared by mixing 180 to 480 parts by weight of the solvent, 10 to 30 parts by weight of the photoinitiator, and 2 to 8 parts by weight of the leveling agent, based on 100 parts by weight of the acrylate-based curable resin.

Meanwhile, the ultraviolet-curable resin composition may further include additives such as an ultraviolet stabilizer or a thermal stabilizer.

The ultraviolet stabilizer serves to block or absorb ultraviolet light, thereby preventing decomposition, discoloration, or deterioration of mechanical properties that may occur when the cured hard coating layer is exposed to ultraviolet light. The ultraviolet stabilizer may include phenyl salicylate, benzophenone, benzotriazole, nickel derivatives, radical scavengers, and the like. The ingredients may be used alone or in combination of two or more, and the type thereof is not limited as long as it does not affect the initial color of the hard coating layer.

The thermal stabilizer may include commercially available polyphenol-based stabilizers (primary stabilizers), phosphate-based stabilizers, and lactone-based stabilizers (secondary stabilizers), which may be used alone or in combination, and two or more types may also be applied together.

The ultraviolet stabilizer or the thermal stabilizer may be used in an amount appropriately adjusted within a range that does not affect ultraviolet curability, and specifically may be included in an amount of 0.01 to 3.5 parts by weight based on 100 parts by weight of the entire ultraviolet-curable resin composition of the present disclosure.

Next, the manufacturing method may include preparing a coating solution by mixing silica aerogel and functional additives with the resin composition.

The silica aerogel used in this step includes a plurality of nano-sized pores, thereby effectively controlling light scattering and providing anti-glare (AG) and anti-reflection (AR) effects. That is, the silica aerogel plays a key role in a highly transparent hard coating film requiring optical performance.

In addition, the silica aerogel exhibits excellent anti-fouling (AF) properties. When used together with a fluorine-based anti-fouling resin, the silica aerogel further enhances anti-fouling performance due to the structural characteristics of the aerogel.

Meanwhile, the silica aerogel has relatively weak anti-bacterial (AB) properties. However, when used in combination with a conventional antibacterial agent, the silica aerogel may induce a synergistic effect. Since the antibacterial agent is incorporated within the pores of the aerogel and is not easily removed by external friction, excellent long-term antibacterial durability can be achieved. In other words, the silica aerogel serves as a promoter, so that the functional additives are not merely added but induce mutual synergy among respective functions within the entire mixed coating solution.

As described above, the present disclosure, centered on the silica aerogel, optimizes ingredients and contents of conventionally known functional additives, thereby simultaneously realizing anti-glare (AG), anti-reflection (AR), anti-fouling (AF), and anti-bacterial (AB) functions within a single composition.

More specifically, the silica aerogel may have a particle size of 1 to 20 μm and a pore size of 3 to 200 nm, more preferably a particle size of 1 to 15 μm and a pore size of 20 to 100 nm, and most preferably a particle size of 1 to 10 μm and a pore size of 20 to 60 nm. When the particle size or the pore size is less than the above range, mechanical properties such as hardness and scratch resistance of the coating film may be excellent, but optical properties such as haze and transmittance may deteriorate. Conversely, when the particle size or the pore size exceeds the above range, optical properties may improve, but mechanical properties may deteriorate. During preparation of the coating solution, the ultraviolet-curable resin composition may be excessively absorbed, thereby increasing viscosity and adversely affecting coatability and uniformity of the coating film. Therefore, it is preferable to use silica aerogel within the above range.

In addition, the silica aerogel may have a porosity of 96 to 99%, and more preferably a porosity of 98 to 99%.

The functional additive may be an anti-fouling resin, an antistatic agent, or an antibacterial agent.

The functional additive may be prepared by sequentially mixing the anti-fouling resin, the antistatic agent, or the antibacterial agent with the resin composition, and after adding each ingredient, stirring may be performed for one to five minutes before introducing the next ingredient.

Similarly, the mixing may be carried out using a general high-speed stirrer at a speed of 100 to 1,000 rpm, and, if necessary, an ultrasonic disperser may be used alone or in combination with the stirring.

More specifically, the anti-fouling resin may be an ultraviolet-curable acrylate-based compound including a fluorine-based UV-curable functional group, and serves to provide anti-fouling properties and abrasion resistance.

The anti-fouling resin may include acrylates, methacrylates, or vinyl compounds into which a perfluoro group is introduced. Preferably, the structure may include 1 to 6 ultraviolet-curable functional groups within a molecule, but is not limited thereto, and any material containing a fluorine group and having an ultraviolet-curable functional group may be used. For example, fluorine-based acrylates such as 2,2,2-trifluoroethyl acrylate, 2,2,3,3,3-pentafluoropropyl acrylate, 2-(perfluorobutyl)ethyl acrylate, 2-(perfluorohexyl)ethyl acrylate, and methyl α-trifluoromethacrylate may be used.

The antistatic agent may include any conductive nanoparticles. For example, the antistatic agent may be selected from the group consisting of conductive polymers, nano metal oxides, nano-dispersed carbon-based materials, and cationic or anionic surfactants. In addition, any known material may be used without limitation as long as it exhibits good compatibility with an organic solvent and does not cause aggregation.

More preferably, the antistatic agent may be a PEDOT/PSS dispersion, a PAN/PSS dispersion, or soluble self-doped PEDOT. In this case, the antistatic agent shows excellent effects in terms of durability, appearance color, optical properties, compatibility with the resin, and long-term stability.

The antibacterial agent may be any known nano metal- or organic-based material without limitation. For example, the nano metal material may be nano silver (Ag), nano silver-metal composite (AgM), nano copper (Cu), nano zinc oxide (ZnO), or zinc-based salt (ZnX salt). The organic-based material may be a quaternary ammonium compound. More preferably, the antibacterial agent may be the nano metal material. A coating solution including the antibacterial agent may exhibit excellent performance in terms of physical property stability, long-term persistence of antibacterial effects, compatibility with the substrate, and resistance to condensation.

Based on 100 parts by weight of the resin composition, 1 to 7 parts by weight of the silica aerogel, 1 to 5 parts by weight of the anti-fouling resin, 15 to 36 parts by weight of the antistatic agent, and 3 to 8 parts by weight of the antibacterial agent may be mixed. More preferably, 2 to 5 parts by weight of the silica aerogel may be mixed based on 100 parts by weight of the resin composition.

When the amount of the silica aerogel is less than the above range, the anti-glare and low-reflection effects intended by the present disclosure may not be sufficiently exhibited. That is, optical properties such as light transmittance, haze, and minimum reflectance may all deteriorate. When the amount exceeds the above range, as described above, the optical properties may be temporarily improved. However, since the ultraviolet-curable resin composition may be excessively absorbed and viscosity may increase, coatability and uniformity of the coating film may be adversely affected. Therefore, it is characterized in that the silica aerogel is added within the above range.

When the amount of the anti-fouling resin is less than the above range, it is difficult to sufficiently secure an initial contact angle and abrasion resistance, which are indicators of anti-fouling performance. When the amount of the anti-fouling resin exceeds the above range, anti-fouling performance may be maintained, but haze among optical properties may sharply increase, and hardness, which is a mechanical property, may deteriorate. In particular, since the anti-fouling resin is an expensive raw material, manufacturing cost increases, which is undesirable in terms of economic efficiency.

When the amount of the antistatic agent is less than the above range, surface resistance may be 10¹³Ω/□ or more, making it difficult to sufficiently secure antistatic performance. When the amount of the antistatic agent exceeds the above range, surface resistance may be reduced to 10¹³Ω/□ or less and antistatic performance may be excellent. However, due to coloration, light transmittance among optical properties may decrease, anti-fouling performance such as initial contact angle and abrasion resistance may deteriorate, and there may also be a risk of long-term compatibility issues (shock phenomenon) with the hard coating solution.

When the amount of the antibacterial agent is less than the above range, antibacterial effects may not be sufficiently exhibited. When the amount of the antibacterial agent exceeds the above range, antibacterial properties may be excellent, but anti-fouling properties (initial contact angle and abrasion resistance) may deteriorate, resulting in an imbalance in overall performance, which is undesirable.

As described above, the present disclosure is technically characterized in that the particle characteristics of the silica aerogel are precisely controlled and the types and contents of the functional additives are optimized. Through the configuration, a total of five functions, namely anti-glare (AG), anti-reflection (AR), anti-fouling (AF), anti-static (AS), and anti-bacterial (AB), can be simultaneously achieved within a single composition using only a single coating solution.

Next, the manufacturing method of the multifunctional hard coating film may include forming a coating layer by coating the coating solution on a transparent polymer substrate.

The transparent polymer substrate may be a layer including at least one selected from the group consisting of polyethylene terephthalate (PET), polycarbonate (PC), polymethyl methacrylate (PMMA), polyimide (PI), polyphenylene sulfide (PPS), polyethylene naphthalate (PEN), polyethersulfone (PES), and allyl resin. More preferably, the transparent polymer substrate may include at least one selected from the group consisting of polyethylene terephthalate (PET), polymethyl methacrylate (PMMA), and polycarbonate (PC).

The transparent polymer substrate may have a thickness of 10 to 500 μm, more preferably 15 to 300 μm, and most preferably 30 to 250 μm.

The coating may be performed by applying the coating solution as a single layer onto the transparent polymer substrate using a method such as bar coating, spin coating, slot-die coating, or roll-to-roll (R2R) coating.

In this case, the coating solution may be applied to a thickness of 1 to 20 μm, more preferably 2 to 10 μm.

In the conventional art, in order to simultaneously realize functions such as anti-glare (AG), anti-reflection (AR), and hard coating (HC), a multilayer structure of two or more layers has been required. Accordingly, complicated manufacturing processes such as securing compatibility between materials of respective layers and performing individual curing processes have been necessary. However, the hard coating film having the single layer according to the present disclosure not only simplifies the process by reducing the number of layers but also provides an effect of achieving high yield.

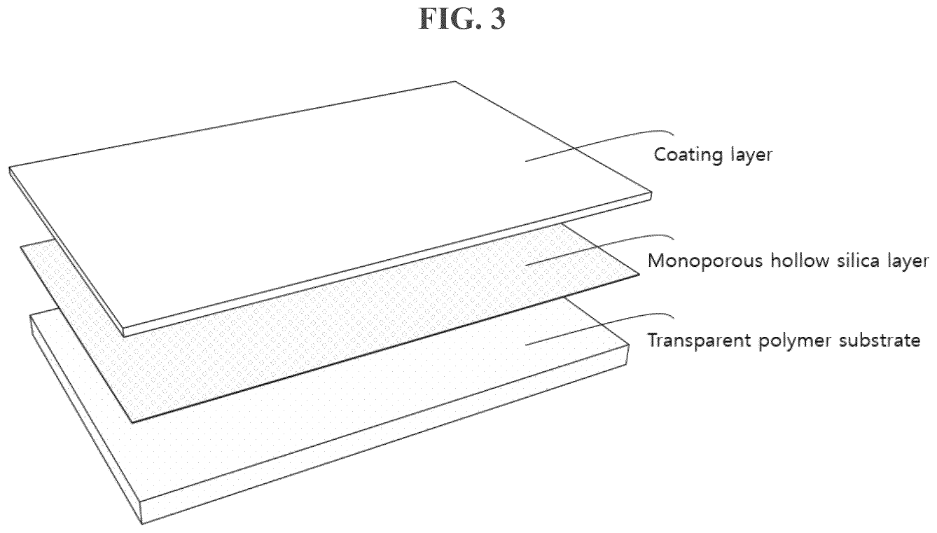

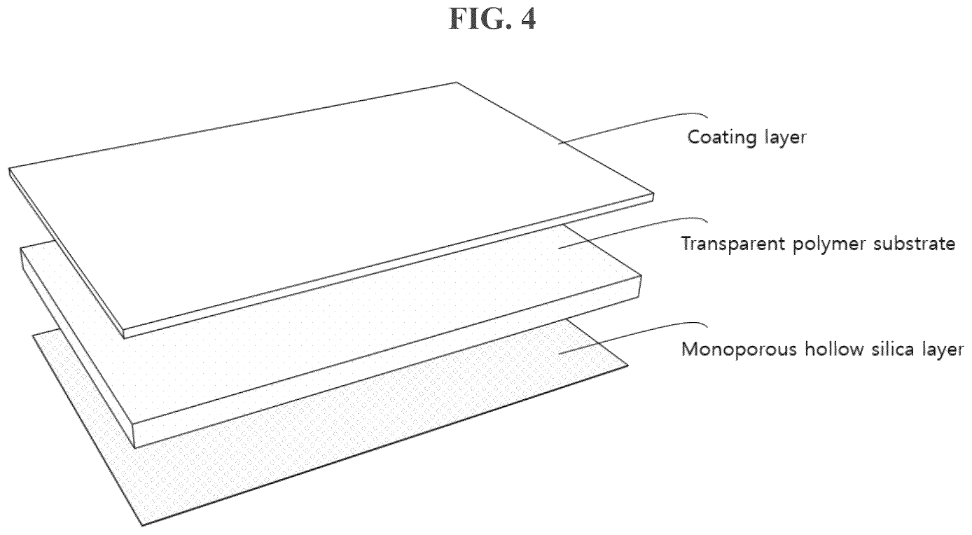

Furthermore, in order to maximize the anti-reflection (AR) effect in specific environments (such as medical high-resolution monitors, precision optical sensors, semiconductor lithography equipment, and the like), the present disclosure provides a multilayer (two-layer) hard coating film. As illustrated in FIGS. 3 and 4, the multilayer hard coating film may be achieved by laminating a mesoporous hollow silica layer directly above or directly below the transparent polymer substrate.

The mesoporous silica layer may include mesoporous hollow silica having a particle size of 40 to 100 nm. Since the mesoporous hollow silica includes numerous fine pores, the average refractive index thereof is lower than that of a general silica layer, thereby functioning as a low-refractive index layer. Such a low-refractive index layer can maximize anti-reflection (AR) performance while minimizing interference among functions.

Next, the manufacturing method of the multifunctional hard coating film may include curing the coating layer by irradiating the coating layer with ultraviolet light.

Preferably, before performing ultraviolet irradiation, drying may be conducted at a temperature of 80 to 100° C. for one to five minutes, followed by ultraviolet irradiation. The ultraviolet irradiation may be performed using an ultraviolet irradiation apparatus having a mercury lamp or a metal halide lamp as a light source, with a light dose of 400 to 1500 mJ/cm² to cure the coating layer.

The hard coating film manufactured as described above can simultaneously realize five functions, namely, anti-glare (AG), anti-reflection (AR), anti-fouling (AF), anti-static (AS), and anti-bacterial (AB). Moreover, the hard coating film exhibits improved effects in terms of film hardness, abrasion resistance, and scratch resistance, which have been major drawbacks of conventional hard coating films.

Meanwhile, the present disclosure provides a hard coating solution including: an ultraviolet-curable resin composition including an acrylate-based curable resin, a solvent, a photoinitiator, and a leveling agent; silica aerogel; an anti-fouling resin; an antistatic agent; and an antibacterial agent.

The ultraviolet-curable resin composition may include 180 to 450 parts by weight of the solvent, 10 to 30 parts by weight of the photoinitiator, and 2 to 8 parts by weight of the leveling agent, based on 100 parts by weight of the acrylate-based curable resin.

In a preferred embodiment of the present disclosure, the hard coating solution may include 1 to 8 parts by weight of the silica aerogel, 1 to 5 parts by weight of the anti-fouling resin, 15 to 30 parts by weight of the antistatic agent, and 3 to 8 parts by weight of the antibacterial agent, based on 100 parts by weight of the ultraviolet-curable resin composition.

In another preferred embodiment of the present disclosure, the hard coating solution may further include mesoporous hollow silica. The hollow silica may be included in an amount of 50 to 200 parts by weight based on 100 parts by weight of the silica aerogel.

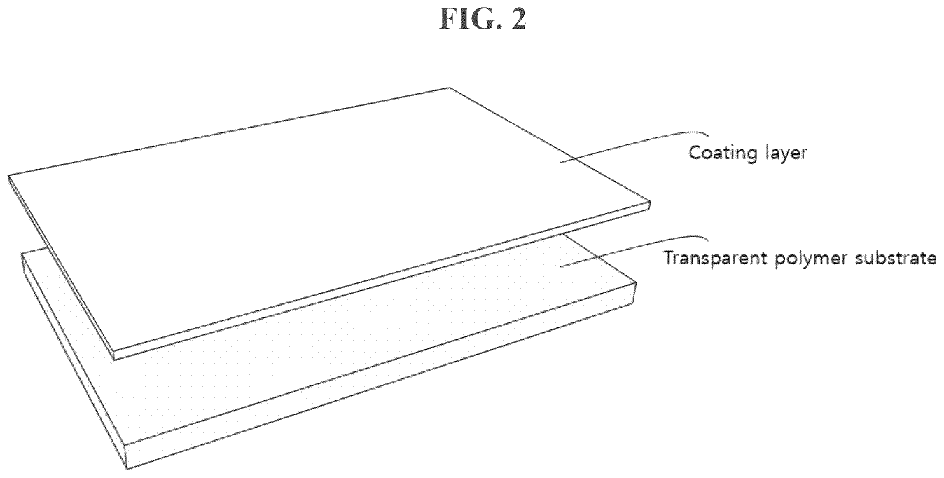

Furthermore, as illustrated in FIG. 2, the present disclosure provides a multifunctional single-layer hard coating film characterized in that the hard coating solution is formed as a single layer on a transparent polymer substrate.

In this case, the transparent polymer substrate layer may have a thickness of 10 to 500 μm, more preferably 15 to 300 μm, and most preferably 30 to 250 μm. The thickness of the single layer may be 1 to 20 μm, more preferably 2 to 10 μm.

The multifunctional multilayer hard coating film according to the present disclosure includes: a transparent polymer substrate layer; a mesoporous hollow silica layer formed on the transparent polymer substrate layer; and a functional film layer formed on the mesoporous hollow silica layer from the hard coating solution.

In this case, the transparent polymer substrate layer may have a thickness of 10 to 500 μm, more preferably 15 to 300 μm, and most preferably 30 to 250 μm. The thickness of the functional film layer formed from the hard coating solution may be 1 to 20 μm, more preferably 2 to 10 μm.

The thickness of the mesoporous hollow silica layer may be 60 to 300 nm.

The mesoporous hollow silica layer according to the present invention may include spherical mesoporous hollow silica. Conventionally known mesoporous hollow silica may be used as the hollow silica, which is characterized by having an outer shell made of silica and a single hollow core formed therein. Such mesoporous hollow silica particles have structural characteristics distinct from those of aerogels, and may serve to improve reflectance among optical properties while maintaining inherent physical properties within the coating solution.

The mesoporous hollow silica may have a particle size of 20 to 300 nm, more preferably 40 to 100 nm, and most preferably 50 to 80 nm.

The present disclosure also provides a multifunctional multilayer hard coating film including: a mesoporous hollow silica layer; a transparent polymer substrate layer formed on the mesoporous hollow silica layer; and a functional film layer formed on the transparent polymer substrate layer from the hard coating solution. Likewise, the transparent polymer substrate layer may have a thickness of 10 to 500 μm, more preferably 15 to 300 μm, and most preferably 30 to 250 μm. The thickness of the functional film layer formed from the hard coating solution may be 1 to 20 μm, more preferably 2 to 10 μm.

Moreover, the thickness of the mesoporous hollow silica layer may be 60 to 300 nm.

Similarly, the mesoporous hollow silica layer according to the present invention may include spherical mesoporous hollow silica. The mesoporous hollow silica may have a particle size of 20 to 300 nm, more preferably 40 to 100 nm, and most preferably 50 to 80 nm.

Hereinafter, embodiments of the present disclosure will be described in detail. However, it is apparent that the present disclosure is not limited by the following embodiments.

Advantages and features of the present disclosure, and methods for achieving them, will become apparent with reference to the embodiments described in detail below. However, the present disclosure is not limited to the embodiments disclosed below and may be realized in various different forms. The embodiments are provided only to ensure that the disclosure of the present invention is complete and to fully inform those skilled in the art of the scope of the present disclosure, and the present disclosure is defined only by the scope of the appended claims.

### 1. PREPARATION EXAMPLES

### 1-1. Preparation Example 1

### \textcircled{1} Preparation of Ultraviolet-Curable Resin Composition

First, 393 parts by weight of a mixed solvent PGME/IPA (6:4 ratio) was added to 100 parts by weight of a mixed UV resin and placed in a prepared stirrer, followed by stirring at 500 rpm for three minutes. At this time, the mixed UV resin was a product of Miwon Co., Ltd., and a mixture of multifunctional aliphatic urethane acrylate SC2100 (9 functional groups), PU5000 (6 functional groups), and multifunctional acrylate monomer M4004 (4 functional groups) in a weight ratio of 6:2:2 was used. Subsequently, 20 parts by weight of a photoinitiator was added, and 6 parts by weight of BYK371 (10% in PGME), manufactured by BYK-Chemie GmbH, was added as a leveling agent, followed by stirring to prepare an ultraviolet-curable resin composition.

### \textcircled{2} Preparation of Multifunctional Hard Coating Solution

With respect to 100 parts by weight of the ultraviolet-curable resin composition, 2.6 parts by weight of aerogel (1-10 μm) manufactured by HONG HITECH was mixed. Next, 1.3 parts by weight of AF resin X-71-1203M (20% in PGME) manufactured by Shin-Etsu as an anti-fouling agent, 9 parts by weight of SEPLEGYDA SAS-PE-H02A (5% in IPA), which was a PEDOT/PSS-based material manufactured by Shin-Etsu, as an antistatic agent, and nano Ag (3% in PGME) manufactured by PE Solve Co. as an antibacterial agent were sequentially added, followed by stirring to prepare a multifunctional hard coating solution.

### 1-2. Preparation Examples 2 to 6

The same procedure as in Preparation Example 1 was performed, except that the amounts of the solvent, the photoinitiator, and the leveling agent were varied as shown in Table 1 below.

### 1-3. Preparation Example 7

The same procedure as in Preparation Example 1 was performed, except that the amounts of the solvent, the photoinitiator, and the leveling agent were varied as shown in Table 1 below. At this time, FN-H60 (particle size: 60 nm) manufactured by FNCC was used as the hollow silica.

TABLE 1

| | | Prep. | Prep. | Prep. | Prep. | Prep. | Prep. | Prep. |
|---|---|---|---|---|---|---|---|---|
| | | Ex. 1 | Ex. 2 | Ex. 3 | Ex. 4 | Ex. 5 | Ex. 6 | Ex. 7 |
| \textcircled{1} | UV resin | 100 | 100 | 100 | 100 | 100 | 100 | 100 |
| | Solvent | 393 | 196 | 386 | 383 | 326 | 413 | 380 |
| | Photo-initiator | 20 | 12 | 20 | 20 | 20 | 20 | 20 |
| | Leveling agent | 6 | 4 | 6 | 6 | 6 | 6 | 6 |
| \textcircled{2} | Silica aerogel | 2.6 | 2.6 | 3.9 | 2.6 | 2.9 | 2.4 | 2.6 |
| | Hollow silica | 0 | 0 | 0 | 0 | 0 | 0 | 2.6 |
| | AF resin | 1.3 | 1.3 | 1.3 | 2.0 | 1.5 | 1.2 | 1.3 |
| | AS agent | 19 | 19 | 19 | 19 | 36 | 18 | 19 |
| | Antibacterial | 5 | 5 | 5 | 5 | 5 | 1 | 5 |
| | agent | | | | | | | |

### 1-4. Preparation Examples 8 to 15

The same procedure as in Preparation Example 1 was performed, except that the amounts of the solvent, the photoinitiator, and the leveling agent were varied as shown in Table 2 below.

TABLE 2

| | | | | Prep. | Prep. | Prep. | Prep. | Prep. | Prep. |
|---|---|---|---|---|---|---|---|---|---|
| | | Prep. | Prep. | Ex. | Ex. | Ex. | Ex. | Ex. | Ex. |
| | | Ex. 8 | Ex. 9 | 10 | 11 | 12 | 13 | 14 | 15 |
| \textcircled{1} | UV resin | 100 | 55 | 100 | 100 | 100 | 100 | 100 | 100 |
| | Solvent | 405 | 366 | 399 | 373 | 480 | 260 | 418 | 340 |
| | Photo- | 20 | 20 | 20 | 20 | 20 | 20 | 20 | 20 |
| | initiator | | | | | | | | |
| | Leveling | 6.7 | 6.7 | 6.7 | 6.7 | 6.7 | 6.7 | 6.7 | 6.7 |
| | agent | | | | | | | | |
| \textcircled{2} | Silica | 0.3 | 7.7 | 2.5 | 2.7 | 2.5 | 2.7 | 2.2 | 3.4 |
| | aerogel | | | | | | | | |
| | Hollow | 0 | 0 | 0 | 0 | 0 | 0 | 0 | 0 |
| | silica | | | | | | | | |
| | AF resin | 1.3 | 1.3 | 0.1 | 5.4 | 1.3 | 1.3 | 1.1 | 1.7 |
| | AS agent | 19 | 19 | 19 | 20 | 3 | 46 | 16 | 26 |
| | Antibac- | 5 | 5 | 5 | 5 | 5 | 5 | 0.2 | 20.6 |
| | terial | | | | | | | | |
| | agent | | | | | | | | |

### 2. EXAMPLES

### 2-1. Example 1

The hard coating solution of Preparation Example 1 was applied to PET 50 manufactured by SK using a bar coater to a predetermined thickness, dried at 90° C. for about two minutes, and then cured in a UV curing apparatus with a light dose of 800 mJ/cm². After curing, the final coating thickness was adjusted to 5 μm to prepare a final multifunctional hard coating film.

### 2-2. Examples 2 to 7

The same procedure as in Example 1 was performed, except that the type of the hard coating solution was changed as shown in Table 3 below.

TABLE 3

| | Example 1 | Example 2 | Example 3 | Example 4 | Example 5 | Example 6 | Example 7 |
|---|---|---|---|---|---|---|---|
| Hard coating | Prep. Ex. 1 | Prep. Ex. 2 | Prep. Ex. 3 | Prep. Ex. 4 | Prep. Ex. 5 | Prep. Ex. 6 | Prep. Ex. 7 |
| solution | | | | | | | |

### 2-3. Comparative Examples 1 to 8

The same procedure as in Example 1 was performed, except that the type of the hard coating solution was changed as shown in Table 4 below.

TABLE 4

| | Comp. | Comp. | Comp. | Comp. | Comp. | Comp. | Comp. | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Hard | Prep. | Prep. | Prep. | Prep. | Prep. | Prep. | Prep. | Prep. |
| coating | Ex. 8 | Ex. 9 | Ex. 10 | Ex. 11 | Ex. 12 | Ex. 13 | Ex. 14 | Ex. 15 |
| solution | | | | | | | | |

### 3. EXPERIMENTAL EXAMPLES

The hard coating films of Examples 1 to 7 and Comparative Examples 1 to 8 were comprehensively evaluated for mechanical properties, optical properties, AF properties, AS properties, and antibacterial properties. In particular, through Comparative Examples 1 to 8, deterioration of properties when specific mixing amounts such as functional additives deviated from the defined ranges was confirmed.

### 3-1. Test Methods

### (1) Pencil Hardness

According to ASTM D3363, hardness of the surface of the hard coating film was measured using a pencil hardness tester under a load of 1 kg. A MITSUBISHI pencil lead was exposed by about 3 to 4 mm in a cylindrical shape, and the tip was polished to be flat and sharp before use. At least three points were measured, and an average value was calculated.

### (2) Scratch Resistance Evaluation

A Steel Wool Tester (WT-LCM100, Korea Protecsa) was used. Steel wool (#0000) manufactured by BONSTAR was used to reciprocally rub the surface under a load of 1 kg/cm² at a speed of 40 cycles/min. Thereafter, the occurrence of scratches on the film surface was evaluated by visual inspection.

### <Evaluation Criteria>

⊚: 10 or fewer scratches of 1 mm or less
∘: 3 or fewer scratches of 1 to 10 mm
Δ: 3 or more scratches of 1 to 10 mm
X: 3 or more scratches of 10 mm or more

### (3) Bending Property

A repetitive bending tester (Type: DLDM111LHA) manufactured by CASIO was used. The film was folded such that the hard coating layers faced each other, and bending was repeated 100 times to form a curvature radius at the folded portion. Cracks or delamination of the coating film were observed.

### (4) Transmittance and (5) Haze

Transmittance and haze were measured using a Color and Haze Meter (CSCP-700, CHN Spec) manufactured by CP Industry. Transmittance was evaluated according to JIS K 7361 (ISO 13468), and haze was evaluated according to JIS K 7136 (ISO 14782).

### (6) Reflectance

The hard coating film was laminated onto a black PET film to eliminate back reflection, and reflectance was measured using an integrating sphere reflectance meter (CM-3700A, Konica Minolta).

### (7) Initial Contact Angle

A contact angle meter (DSA10) manufactured by KRUSS was used to measure the contact angle of water on a surface of the hard coating film. At room temperature, a 3 μL droplet of water was dropped, measurements were taken at six points, and an average value was calculated.

### (8) AF Abrasion Resistance

An abrasion tester manufactured by Daesung Precision was used. After rubbing the surface of the hard coating film 2000 times with an abrasion test eraser under a 1 kg load, the contact angle was measured using a contact angle meter manufactured by KRUSS. Measurements were taken at least at three points, and an average value was calculated. A contact angle of 95° or more was set as the acceptance criterion for AF abrasion resistance.

### (9) Surface Resistance

Surface resistance was measured as sheet resistance (Ω/sq) of the hard coating film using a resistance meter (MCP-HT450, Hiresta).

### (10) Antibacterial Activity

Testing was conducted by FITI Testing & Research Institute according to JIS Z 2801 against Escherichia coli and Staphylococcus aureus. Antibacterial activity (%) was calculated by comparing the initial bacterial count with the bacterial count after a predetermined period.

### 3-2. Experimental Results

As a result of the experiments, as shown in Table 5 below, Example 1 secured mechanical strength with a pencil hardness of 2H, scratch resistance rated as ∘, and bending property of 1R. The optical properties were also relatively favorable, showing a transmittance of 92.8% and a reflectance of 3.8%. Furthermore, AF, AS, and AB functions were stably realized at or above a predetermined level, with a contact angle of 116°, AF abrasion resistance of 100 cycles, surface resistance of 10⁹Ω/□, and antibacterial activity of 99.0%. Overall, Example 1 exhibited harmonized characteristics at an intermediate or higher level in terms of total functionality. Example 1 serves as a baseline that satisfies the minimum implementation conditions of each functional ingredient and maintains performance balance.

Example 2, representing the core composition of the present disclosure, exhibited excellent mechanical durability, including a pencil hardness of 3H, scratch resistance rated as ⊚, and bending property of 1.5R. Optical performance for AG/AR was also well balanced, with a transmittance of 94.2%, haze of 72.4%, and reflectance of 3.0%. Additionally, AF characteristics were excellent, showing an initial contact angle of 118° and abrasion resistance of 102 cycles. Antibacterial activity was maintained at 99.5% or more. Accordingly, Example 2 is evaluated as an optimal composition in which all properties were uniformly outstanding.

On the other hand, as shown in Table 6 below, Comparative Example 2, in which the silica aerogel content exceeded the upper limit, exhibited haze increased to 90.2%, thereby securing light scattering performance. However, scratch resistance was reduced to a level between Δ and ∘, resulting in weakened mechanical protection. It indicates that emphasizing optical properties alone may disrupt overall performance balance.

In addition, Examples 3 and 4 exhibited enhanced optical performance with haze values of 85.3% and 82.5%, respectively and secured balanced AF and durability characteristics by maintaining contact angles of 128° and 125° and abrasion resistance of 98 and 105 cycles, respectively. Accordingly, Example 4 achieved a scratch resistance rating of ⊚.

Meanwhile, Comparative Example 3, in which the AF resin content was below the lower limit, showed a reduced contact angle of 105° and abrasion resistance of only 80 cycles, and scratch resistance was rated as X, indicating significantly deteriorated mechanical durability. It indicates that insufficient AF resin content leads to substantial degradation of protective performance.

Comparative Example 5, in which the AS component exceeded the upper limit, exhibited a surface resistance increased to 10¹²Ω/□, thereby exceeding the effective range for antistatic performance.

Example 6 achieved top-level performance in AF and antibacterial properties, recording an initial contact angle of 120° and antibacterial activity of 99.9%. In contrast, Comparative Example 7, in which the antibacterial agent content deviated from the lower limit, exhibited antibacterial activity of only 60% against Escherichia coli and 50% against Staphylococcus aureus, indicating insufficient antibacterial effect.

Additionally, Example 7 demonstrated excellent optical performance (haze 88%, reflectance 2.0%) and antibacterial activity (99.5%), confirming that it is suitable for applications requiring both high transparency and hygienic performance. Conversely, Comparative Example 8 maintained antibacterial activity but exhibited low contact angle and abrasion resistance, indicating insufficient AF performance.

TABLE 5

| | | Ex. 1 | Ex. 2 | Ex. 3 | Ex. 4 | Ex. 5 | Ex. 6 | Ex. 7 |
|---|---|---|---|---|---|---|---|---|
| Mechanical | Pencil Hardness | 2 H | 3 H | 2 H | 2 H | 2 H | 2 H | 2 H |
| Properties | Scratch Resistance | ◯ | ⊚ | ◯~Δ | ◯~⊚ | ◯ | ◯ | ◯~Δ |
| | Bending Property | 1 R> | 1.5 R | 1 R | 1 R> | 1 R> | 1 R> | 1 R |
| | (mm) | | | | | | | |
| Optical | Transmittance (%) | 94.8 | 94.2 | 94.8 | 94.8 | 94.8 | 94.8 | 95.2 |
| Properties | Haze(%) | 80.2 | 72.4 | 85.3 | 82.5 | 80.1 | 80.2 | 88 |
| | Minimum | 2.5 | 3.0 | 2.2 | 2.5 | 2.5 | 2.5 | 2.0 |
| | Reflectance (%) | | | | | | | |
| AF | Initial Contact | 120 | 118 | 128 | 125 | 118 | 120 | 125 |
| Properties | Angle (°) | | | | | | | |
| | Abrasion Resistance | 100 | 102 | 98 | 105 | 98 | 100 | 96 |
| | (cycles) | | | | | | | |
| AS | Resistance(Ω/□) | 10\hat{ }9 | 10\hat{ }9 | 10\hat{ }9 | 10\hat{ }9 | 10\hat{ }8 | 10\hat{ }9 | 10\hat{ }9 |
| Properties | | | | | | | | |
| Antibacterial | Escherichia coli | 99.5< | 99.5< | 99.5< | 99.5< | 99.5< | 99.9< | 99.5< |
| Properties | activity(%) | | | | | | | |
| | Staphylococcus | 99.5< | 99.5< | 99.5< | 99.5< | 99.5< | 99.9< | 99.5< |
| | aureus activity(%) | | | | | | | |

TABLE 6

| | | Comp. | Comp. | Comp. | Comp. | Comp. | Comp. | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 7 | Ex. 8 |
| Mechanical | Pencil Hardness | 2 H | 1~2 H | 2 H | 2 H | 2 H | 1~2 H | 2 H | 2 H |
| Properties | Scratch Resistance | ◯ | Δ~◯ | X | ⊚ | ◯ | ◯ | ◯ | ◯ |
| | Bending Property | 1 R | 1.5 R | 1 R> | 1 R> | 1 R> | 1 R> | 1 R> | 1 R> |
| | (mm) | | | | | | | | |
| Optical | Transmittance (%) | 92.8 | 95.0 | 94.8 | 94.2 | 94.8 | 94.5 | 94.8 | 93 |
| Properties | Haze(%) | 5 | 90.2 | 80.3 | 83.2 | 80.2 | 80 | 80.2 | 80.2 |
| | Minimum | 3.8 | 2.0 | 2.5 | 2.8 | 2.5 | 2.8 | 2.5 | 3.2 |
| | Reflectance (%) | | | | | | | | |
| AF | Initial Contact | 116 | 130 | 105 | 135 | 120 | 118 | 120 | 116 |
| Properties | Angle (°) | | | | | | | | |
| | Abrasion | 110 | 90 | 80 | 105 | 100 | 90 | 100 | 90 |
| | Resistance (cycles) | | | | | | | | |
| AS | Resistance(Ω/□) | 10\hat{ }9 | 10\hat{ }9 | 10\hat{ }9 | 10\hat{ }10 | 10\hat{ }12 | 10\hat{ }8 | 10\hat{ }9 | 10\hat{ }8 |
| Properties | | | | | | | | | |
| Antibacterial | Escherichia coli | 99.0< | 99.5< | 99.5< | 99< | 99.5< | 99.5< | 60> | 99.5< |
| Properties | activity(%) | | | | | | | | |
| | Staphylococcus | 99.0< | 99.5< | 99.5< | 99< | 99.5< | 99.5< | 50> | 99.5< |
| | aureus activity(%) | | | | | | | | |

As described above, it has been confirmed that the hard coating film of the present disclosure uniformly satisfies five functions, namely, anti-glare (AG), anti-reflection (AR), anti-fouling (AF), anti-static (AS), and anti-bacterial (AB)—within a single composition.

From the foregoing description, it will be understood by those skilled in the art that the present disclosure may be embodied in other specific forms without departing from the technical spirit or essential characteristics thereof. In this regard, the embodiments described above should be understood in all respects as illustrative and not restrictive.

1. A manufacturing method of a multifunctional hard coating film, comprising:
preparing an ultraviolet-curable resin composition;
preparing a coating solution by mixing silica aerogel and a functional additive with the resin composition;
forming a coating layer by coating the coating solution on a transparent polymer substrate; and
curing the coating layer by irradiating the coating layer with ultraviolet light.

2. The manufacturing method according to claim 1, wherein the silica aerogel has a particle size of 1 to 20 μm and a pore size of 3 to 200 nm.

3. The manufacturing method according to claim 1, wherein, in the preparing of the coating solution, the coating solution is prepared by mixing 1 to 7 parts by weight of the silica aerogel, 1 to 5 parts by weight of an anti-fouling resin, 15 to 36 parts by weight of an antistatic agent, and 3 to 8 parts by weight of an antibacterial agent, based on 100 parts by weight of the resin composition.

4. The manufacturing method according to claim 1, wherein, in the forming of the coating layer, the transparent polymer substrate has a thickness of 10 to 500 μm.

5. The method according to claim 1, wherein the forming of the coating layer includes coating the coating solution on the transparent polymer substrate as a single layer.

6. The manufacturing method according to claim 1, wherein the forming of the coating layer includes laminating a mesoporous hollow silica layer directly above or directly below the transparent polymer substrate.

7. A hard coating solution comprising:
an ultraviolet-curable resin composition including an acrylate-based curable resin, a solvent, a photoinitiator, and a leveling agent;
silica aerogel;
an anti-fouling resin;
an antistatic agent; and
an antibacterial agent.

8. The hard coating solution according to claim 7, wherein the ultraviolet-curable resin composition includes 180 to 480 parts by weight of the solvent, 10 to 30 parts by weight of the photoinitiator, and 2 to 8 parts by weight of the leveling agent, based on 100 parts by weight of the acrylate-based curable resin.

9. A multifunctional single-layer hard coating film, wherein the hard coating solution according to claim 7 is formed as a single layer on a transparent polymer substrate layer.

10. A multifunctional multilayer hard coating film comprising:
a transparent polymer substrate layer;
a mesoporous hollow silica layer formed on the transparent polymer substrate layer; and
a functional film layer formed on the mesoporous hollow silica layer from the hard coating solution according to claim 7.

11. The multifunctional multilayer hard coating film according to claim 10, wherein a thickness of the functional film layer formed from the hard coating solution is 1 to 20 μm.

12. The multifunctional multilayer hard coating film according to claim 10, wherein a thickness of the mesoporous hollow silica layer is 60 to 300 nm.

13. The multifunctional multilayer hard coating film according to claim 10, wherein the mesoporous hollow silica layer includes mesoporous hollow silica, and
wherein the mesoporous hollow silica has a particle size of 20 to 300 nm.

14. A multifunctional multilayer hard coating film comprising:
a mesoporous hollow silica layer;
a transparent polymer substrate layer formed on the mesoporous hollow silica layer; and
a functional film layer formed on the transparent polymer substrate layer from the hard coating solution according to claim 7.

15. The multifunctional multilayer hard coating film according to claim 14, wherein a thickness of the functional film layer formed from the hard coating solution is 1 to 20 μm.

16. The multifunctional multilayer hard coating film according to claim 14, wherein a thickness of the mesoporous hollow silica layer is 60 to 300 nm.

17. The multifunctional multilayer hard coating film according to claim 14, wherein the mesoporous hollow silica layer includes mesoporous hollow silica, and
wherein the mesoporous hollow silica has a particle size of 20 to 300 nm.
